(19) United States
(12) Patent Application Publication
(10) Pub. No.: US 2014/0171835 A1
(43) Pub. Date: Jun. 19, 2014

(54) Back Treatment Apparatus

(71) Applicants: Philip Solomon, Kibbutz Tzora (IL); Dolev Rafaeli, Creskill, NJ (US)

(72) Inventors: Philip Solomon, Kibbutz Tzora (IL); Dolev Rafaeli, Creskill, NJ (US)

(73) Assignee: RADIANCY, INC., Orangeburg, NY (US)

(21) Appl. No.: 14/237,881

(22) PCT Filed: Aug. 14, 2012
(86) PCT No.: PCT/IL2012/050310

§ 371 Date: Feb. 9, 2014

Related U.S. Application Data
(60) Provisional application No. 61/523,351, filed on Aug. 14, 2011.

(51) Int. Cl. A61H 1/00

(52) U.S. Cl. CPC A61H 1/003
USPC 601/5

(57) ABSTRACT

A back treatment apparatus (10), constituted of: a support member (50) arranged to support a lumbar region (130); a translation mechanism (210); and a control circuitry (100), the control circuitry arranged to control the translation mechanism to translate the support member along a plurality of paths and rotate the support member about at least one axis in a pre-determined range of motion. Preferably, the plurality of paths is constituted of at least: a generally linear path along an axis generally perpendicular in relation to a plane defined by the support member; and a generally linear path along an axis generally parallel in relation to the plane defined by the support member. Preferably, the back treatment apparatus is portable.

### CROSS-REFERENCE TO RELATED APPLICATIONS

The present application claims priority from U.S. provisional application 61/523,351 filed Aug. 14, 2011, entitled “BACK TREATMENT APPARATUS”, the entire contents of which is incorporated herein by reference.

### TECHNICAL FIELD

The present invention relates generally to the field of low back treatment and in particular to continuous passive motion (CPM) treatment of a lumbar region.

### BACKGROUND

Low back pain, also known as lumbago, is a common musculoskeletal disorder affecting 80% of the population at some point in their lives. Lumbago may be classified by the duration of symptoms as: acute, i.e. lasting less than 4 weeks; sub-acute, i.e. lasting 4-12 weeks; or chronic, i.e. lasting more than 12 weeks. The majority of lumbago cases stems from benign musculoskeletal problems, and is often referred to as non-specific low back pain. Such non-specific low back pain may be due to muscle or soft tissue sprain or strain.

Overactivity of the muscles of the back can lead to an injured or torn ligament in the back which in turn leads to pain. An injury can also occur to one of the intervertebral discs (disc tear, disc herniation). Due to aging, discs begin to diminish and shrink in size, resulting in vertebrae and facet joints rubbing against one another. Ligament and joint functionality also diminishes as one ages, leading to spondylolisthesis, which causes the vertebrae to move much more than they should. Pain is also generated through lumbar spinal stenosis, sciatica and scoliosis. At the lowest end of the spine, some patients may have tailbone pain (also called coccyx pain or coccydynia). Others may have pain from their sacroiliac joint, where the spinal column attaches to the pelvis, called sacroiliac joint dysfunction.

In the vast majority of cases, no noteworthy or serious cause is ever identified. Unfortunately, the patient may experience a relatively long period of low to moderate pain with little relief.

Continuous passive motion (CPM) is a known postoperative treatment method designed to aid recovery following joint surgery. For most recovering patients, attempts at independent joint motion causes pain and therefore the patient avoids moving the joint, which can lead to tissue stiffness around the joint and the formation of scar tissue. Ultimately, this may limit a patient's range of motion and require physical therapy to restore the lost motion. A CPM machine moves the joint without the use of a patient's muscles. Thus, CPM is a proven modality used to reduce pain and edema (swelling), increase/maintain range of motion, help prevent adhesions, contractures (muscle/joint stiffness) and DVTs (blood clots in veins that can block blood flow). CPM also promotes faster and more productive cartilage and soft tissue healing.

Low back pain commonly reduces tolerance for the prolonged sitting required by many occupations and routine daily activities. Studies have shown that lumbar continuous passive motion (CPM) improved comfort for subjects without histories of low back pain. Thus, it is believed that lumbar CPM would benefit many patients with low back pain.

Unfortunately, commercial devices to provide lumbar CPM in a convenient simply transportable form are not commercially available.

### SUMMARY

Accordingly, it is a principal object to overcome at least some of the disadvantages of prior art. This is accomplished in certain embodiments by providing a back treatment apparatus, comprising: a support member arranged to support a lumbar region; a translation mechanism; and a control circuitry, the control circuitry arranged to control the translation mechanism to translate the support member along a plurality of paths and rotate the support member about at least one axis in a predetermined range of motion. Preferably, the weight and dimensions of the back treatment apparatus are arranged such that the back treatment apparatus is portable.

In one embodiment, the plurality of paths comprises at least: a generally linear path along an axis generally perpendicular in relation to a plane defined by the support member; and a generally linear path along an axis generally parallel in relation to the plane defined by the support member. In another embodiment, the rotation about the at least one axis comprises one of: a rotational path about an axis generally parallel in relation to a plane defined by the support member; and a rotational path about an axis generally perpendicular in relation to the plane defined by the support member. In one further embodiment, the rotation is about both of the rotational path about an axis generally parallel in relation to the plane defined by the support member and the rotational path about an axis generally perpendicular in relation to the plane defined by the support member.

In one embodiment, the control circuitry is further arranged to control the translation mechanism to translate the support member along the plurality of paths according to a pseudo-random algorithm. In another embodiment, the control circuitry is further arranged to control the translation mechanism such that the translation of the support member is performed at pseudo-random rates of motion.

In one embodiment, the control circuitry is further arranged to control the translation mechanism such that one of the translation and rotation of the support member is performed at a fixed predetermined rate of motion. In another embodiment, the back treatment apparatus further comprises a user input device, wherein the rate of motion of one of the translation and rotation of the support member is responsive to an input at the user input device.

In one embodiment, the distance of translation of the support member along the at least one path is responsive to a pseudo-random algorithm. In another embodiment, the back treatment apparatus further comprises a user input device, wherein the distance of translation of the support member along the at least one path is responsive to an input at the user input device.

In one embodiment, the back treatment apparatus further comprises at least one securing member arranged to secure a lumbar region to the support member. In one further embodiment, the at least one securing member is adjustable. In another embodiment, the rotation is contemporaneous with the translation.

In one independent embodiment a method of providing continuous passive motion to a lumbar region is provided, the method comprising: translating a support member, arranged to support a lumbar region of a user, along at least two orthogonal paths, in accordance with a predetermined pattern arranged to perform lumbar continuous passive motion; and rotating the provided support member about at least one rotational path.

In one embodiment, the rotating is about one of: an axis generally parallel in relation to a plane defined by the provided support member; and an axis generally perpendicular in relation to the plane defined by the provided support member. In one further embodiment, the translating and the rotating are according to a pseudo-random algorithm. In another embodiment, one of the translating and the rotating of the provided support member is performed over a range of rates of motion selected according to a pseudo-random algorithm.

In one embodiment, one of the translating and the rotating of the provided support member is performed at a fixed predetermined rate of motion. In another embodiment, the rate of motion of one of the translation and the rotation is responsive to a user input.

In one embodiment, the distance of translation of the provided support member along each of the orthogonal paths and the amount of rotation of the provided support member is responsive to a pseudo-random algorithm. In another embodiment, the distance of translation of the provided support member along each of the orthogonal paths and the amount of rotation of the provided support member is responsive to a user input.

In one embodiment, the method further comprises securing a lumbar region to the provided support member. In another embodiment, the user is in a supine position.

In one embodiment, the user is in a seated position. In another embodiment, the rotating is contemporaneous with the translating. In one embodiment, the support member is portable.

Additional features and advantages will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1A illustrates a perspective view of a back treatment apparatus supporting a lumbar region of a user in a supine position;

FIG. 1B illustrates a perspective view of a back treatment apparatus supporting a lumbar region of a user in a supine position with the knees bent;

FIG. 1C illustrates a perspective view of a back treatment apparatus supporting a lumbar region of a user in a seated position;

FIG. 2A illustrates a high level schematic diagram of a translation mechanism arranged to linearly translate a support member of FIGS. 1A-1C along an axis generally perpendicular to a plane defined by the support member;

FIG. 2B illustrates a high level schematic diagram of a translation mechanism arranged to rotate a support member of FIGS. 1A-1C about an axis generally perpendicular to the plane defined by the support member;

FIG. 2C illustrates a high level schematic diagram of a translation mechanism arranged to linearly translate a support member of FIGS. 1A-1C along an axis generally parallel to the plane defined by the support member;

FIG. 2D illustrates a high level schematic diagram of a translation mechanism arranged to rotate a support member of FIGS. 1A-1C about an axis generally parallel to the plane defined by the support member;

FIG. 2E illustrates a high level schematic diagram of a translation mechanism arranged to translate a support member of FIGS. 1A-1C along a plurality of paths; and

FIG. 3 illustrates a high level flow chart of a method for providing continuous passive motion to a lumbar region.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

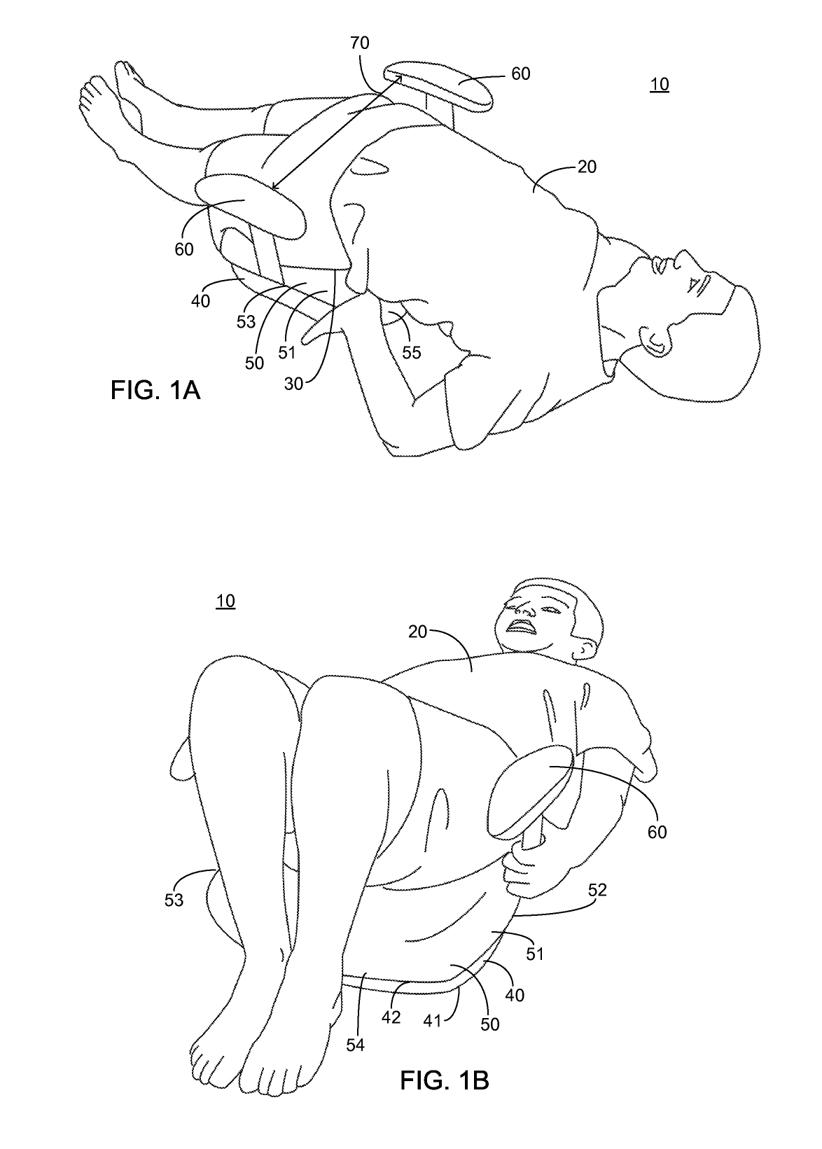

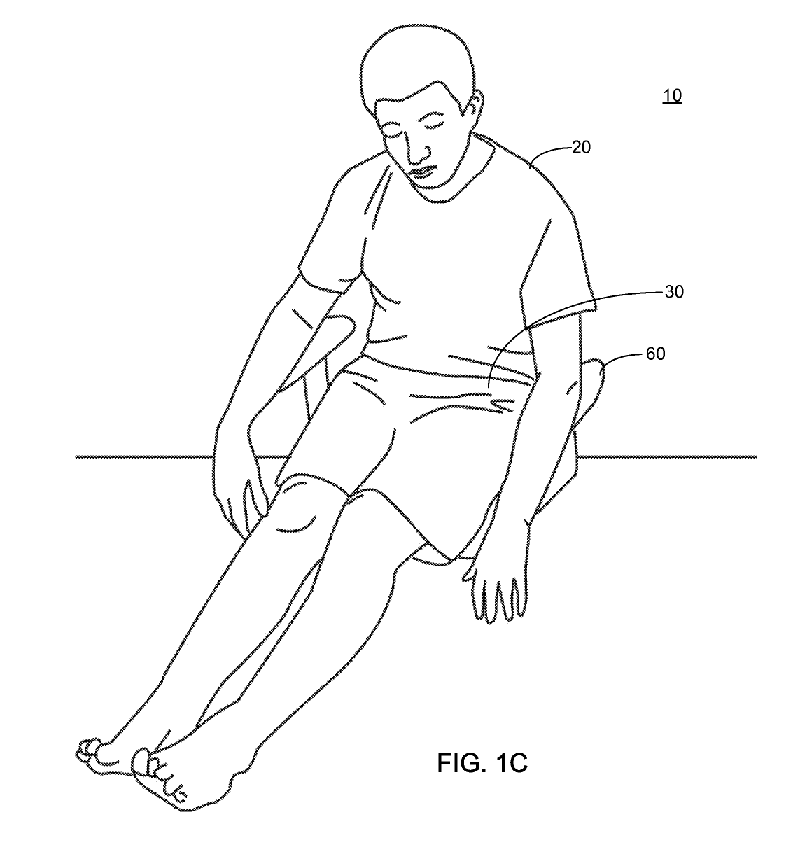

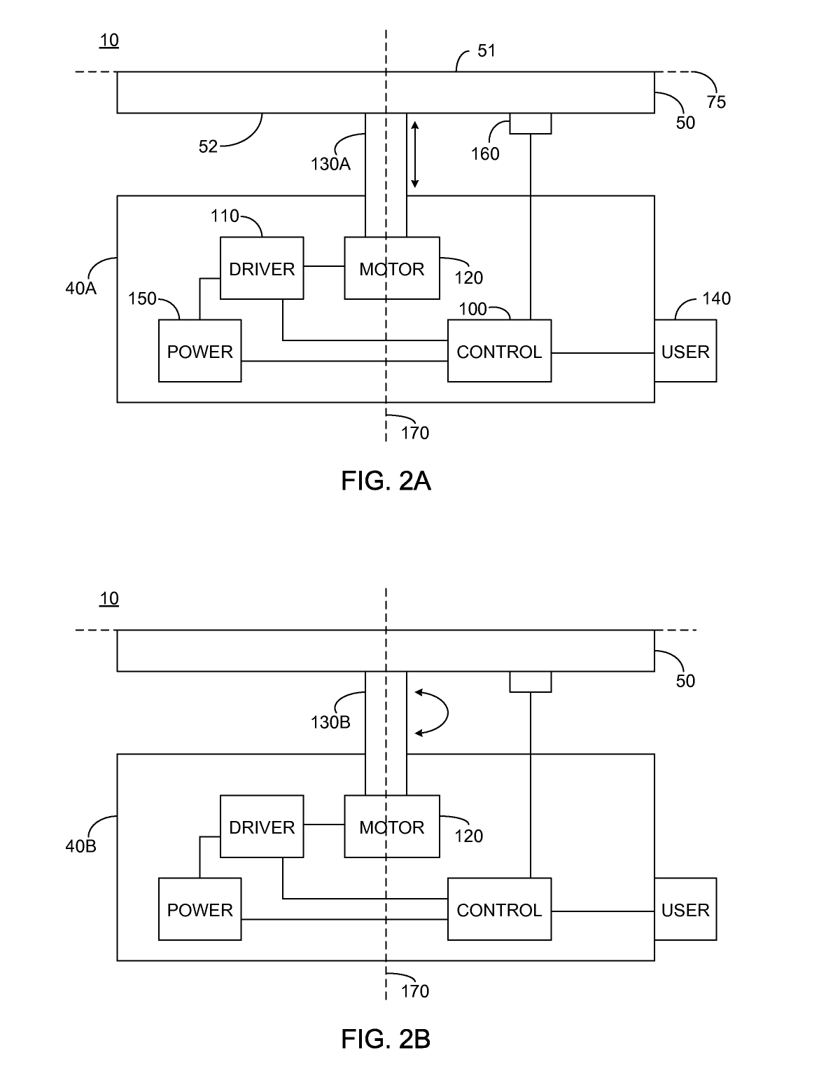

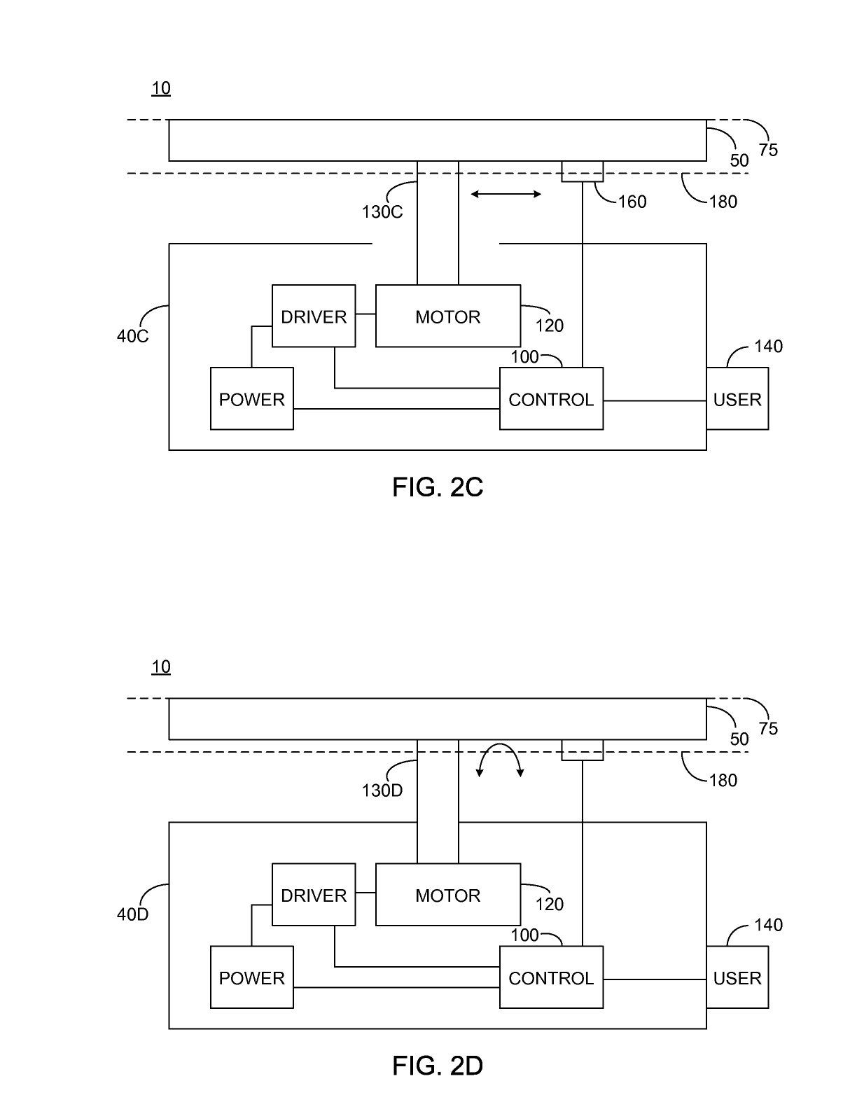

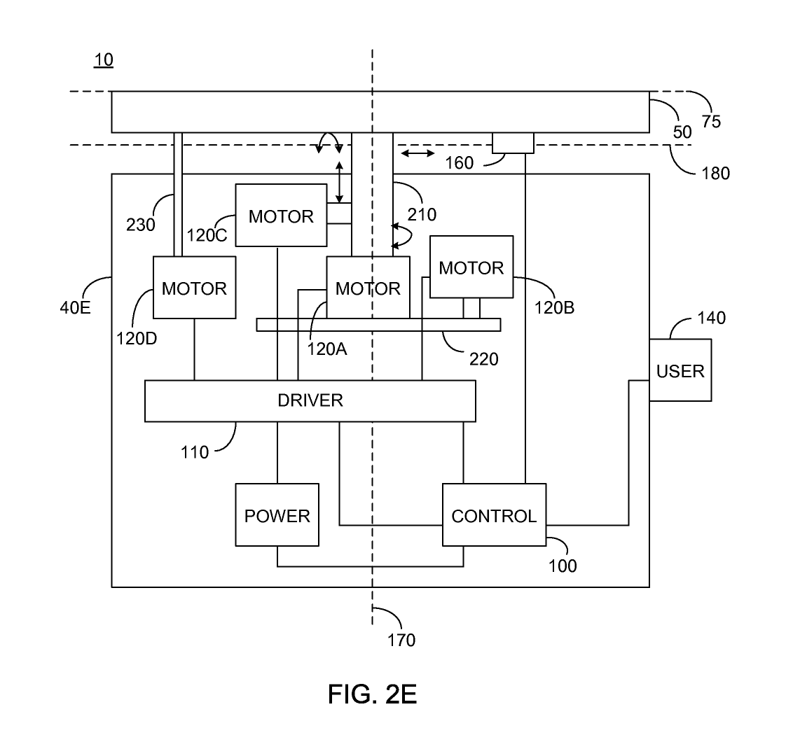

FIG. 1A illustrates a perspective view of a back treatment apparatus 10 arranged for continuous passive motion of a lumbar region 30 of a user 20, with user 20 in a supine position; FIG. 1B illustrates a perspective view of back treatment apparatus 10 with user 20 in a supine position with the knees bent; and FIG. 1C illustrates a perspective view of back treatment apparatus 10 with user 20 in a seated position, the figures being described together. Back treatment apparatus 10 comprises: a base 40 exhibiting a bottom surface 41 and a connection surface 42 opposing bottom surface 41; a support member 50 comprising a support surface 51, a connection surface 52 opposing support surface 51, a pair of opposing side ends 53, a front end 54 and a back end 55 opposing front end 54; and a plurality of optional securing members 60. Support member 50 is arranged to support lumbar region 30 of user 20. In one embodiment, support surface 51 of support member 50 is ergonomically shaped to more effectively support lumbar region 30 of user 20. In one embodiment, support surface 51 of support member 50 comprises a cushioning material. In another embodiment, bottom surface 41 is shaped such that when back treatment apparatus is placed on a floor surface, base 40 remains in a stable position. In one embodiment, the distance between front end 54 and back end 55 of support surface 50 is 40-90 centimeters. In one embodiment, the distance between side ends 53 of support member 50 is 30-70 centimeters. In another embodiment In one embodiment, first and second optional securing members 60 are provided connected to support member 50 on opposing side ends 53 thereof and extending in a direction generally perpendicular to a plane defined by support surface 51 of support member 50. In one embodiment, first and second optional securing members In one further embodiment (not shown), a third optional securing member 60 is provided connected to back end 55 of support member 50 and extending generally in the direction of the extension of first and second optional securing members 60. In one embodiment, the distance between the extensions of optional securing members 60 is adjustable, the distance there between denoted as distance 70. In one embodiment, first and second optional securing members 60 are each ergonomically shaped to allow easy holding thereof by the hands of user 20. Connection surface 42 of base 40 is juxtaposed with connection surface 52 of support member 50 and base 40 is in mechanical communication with support member 50 as will be described further below in relation to FIGS. 2A-2E. In one embodiment, the distance between bottom surface 41 of base 40 and support surface 51 of support member 50 is 5-30 centimeters. In one embodiment, the elements of back treatment apparatus 10 are constructed such that the overall weight of back treatment apparatus 10 is 3-10 kilograms, optionally 5 kilograms. Advantageously, the light weight of back treatment apparatus 10 and the above described dimensions of back treatment apparatus 10 allow back treatment apparatus 10 to be portable.

In operation, a user is situated in relation to support member 50 such that lumbar region 30 is in contact with support surface 51 with the legs of user 20 extending out over front end 54. As illustrated in FIG. 1A, in one embodiment user 20 lies in a supine position with the legs of user 20 being generally in a straight position proceeding substantially in parallel with the plane defined by support surface 51. In another embodiment, as illustrated in FIG. 1B, user 20 lies in the supine position of FIG. 1A with legs of user 20 being at least partially bent. In another embodiment, as illustrated in FIG. 1C, user 20 is in a seated position with lumbar region 30 supported by support surface 51. In the embodiment where a third optional securing member 60 is provided, the back of user 20 rests against third optional support member 60 while in the seated position of FIG. 1C. As will be described below in relation to FIGS. 2A-2E, support member 50 is translated in a plurality of directions thereby applying CPM to lumbar region 30 of user 20. Distance 70 between opposing securing members 60 is preferably adjustable so as to secure user 20 comfortably between opposing securing members 60. In such an embodiment, where the distance 70 between opposing securing members 60 is adjustable, user 20 adjusts first and second optional securing members 60 to more adequately secure the lower pelvis area to support surface 51 of support member 50. In one embodiment, user 20 grabs at least one of first and second securing members 60 with their hands.

FIG. 2A illustrates a high level schematic diagram of the circuitry of a base 40A of back treatment apparatus 10. Base 40A comprises: a control circuitry 100; a driver 110; a motor 120; a translation mechanism 130A; a user input device 140; a power source 150 and a motion sensor 160. User input device 140 is in one non-limiting embodiment any of a touch screen, a plurality of knobs and a plurality of push buttons. Power source 150 is in one embodiment a rechargeable power source. In one embodiment, power source 150 is arranged to be connected to a power mains. In one embodiment, as illustrated, motion sensor 160 is attached to support member 50. An input of control circuitry 100 is coupled to an output of motion sensor 160 and an output of control circuitry 100 is coupled to a respective input of driver 110. An output of driver 110 is coupled to motor 120 and motor 120 is coupled to support member 50, specifically to connection surface 52, via translation mechanism 130A. An output of user input device 140 is coupled to a respective input of control circuitry 100. A power input of each of control circuitry 100 and driver 110 is coupled to a respective output of power source 150.

In operation, responsive to an input at user input device 140, control circuitry 100 controls driver 110 to operate motor 120. Responsive to the operation of motor 120, translation mechanism 130A translates support member 50 along an axis 170 which is generally perpendicular to a plane 75, plane 75 defined by support surface 51 of support member 50. The translation along axis 170 is performed alternately in opposing directions. In one embodiment, the translation of support member 50 along axis 170 is performed at a fixed predetermined speed. In another embodiment, the translation of support member 50 along axis 170 is performed at pseudo-random speeds, i.e. speeds appearing generally random. In one embodiment, the speed of translation is adjusted responsive to an input at user input device 140. Motion sensor 160 is arranged to detect the speed of translation of support member 50 and control circuitry 100 is arranged to further adjust the speed responsive to the output of motion sensor 160. In one embodiment, the distance which support member 50 is translated along axis 170 is a fixed predetermined distance. In another embodiment, the distance which support member 50 is translated along axis 170 is adjusted according to a pseudo-random algorithm, preferably constrained to be within pre-determined translation limits. In one embodiment, the distance which support member 50 is translated along axis 170 is adjusted responsive to an input at user input device 140. Advantageously, the translation of support member 50 along axis 170 provides CPM to lumbar region 30 of user 20.

FIG. 2B illustrates a high level schematic diagram of the circuitry of a base 40B of back treatment apparatus 10. The arrangement and operation of base 40B is in all respects similar to base 40A of FIG. 2A with the exception that translation mechanism 130A is replaced with translation mechanism 130B which is arranged, responsive to the operation of motor 120, to rotate support member 50 about axis 170. The rotation about axis 170 is performed alternately in opposing directions. The rotation of support member 50 about axis 170 is in all respects similar to the translation of support member 50 along axis 170 and in the sake of brevity will not be further described. In one embodiment, the number of degrees of rotation of support member 50 from a default position is a predetermined value, preferably no more than 20°. In another embodiment, the degrees of rotation, and the rate of rotation, are adjusted according to a pseudo-random algorithm, preferably constrained to be within pre-determined translation limits, such as the above preferable 20° limit. In one embodiment, the degrees of rotation of support member 50 about axis 170 and the rate of rotation are adjusted responsive to an input at user input device 140. Advantageously, the rotation of support member 50 about axis 170 provides CPM to lumbar region 30 of user 20.

FIG. 2C illustrates a high level schematic diagram of the circuitry of a base 40C of back treatment apparatus 10. The arrangement and operation of base 40C is in all respects similar to base 40A of FIG. 2A with the exception that translation mechanism 130A is replaced with a translation mechanism 130C which is arranged, responsive to the operation of motor 120, to translate support member 50 along an axis 180 generally parallel to plane 75. The translation along axis 180 is performed alternately in opposing directions. In one embodiment, translation mechanism 130C is arranged to translate support member 50 along axis 180 at a fixed predetermined speed. In one embodiment, the speed of translation is adjusted responsive to an input at user input device 140. In another embodiment, the translation of support member 50 along axis 180 is performed at pseudo-random speeds, i.e. speeds appearing generally random. In one embodiment, the distance which support member 50 is translated along axis 170 is a fixed predetermined distance. In another embodiment, the distance which support member 50 is translated along axis 170 is adjusted according to a pseudo-random algorithm, preferably constrained to be within pre-determined translation limits. Motion sensor 160 is arranged to detect the speed of translation of support member 50 and in one embodiment control circuitry 100 is arranged to further adjust the speed responsive to the output of motion sensor 160. In one embodiment, the pseudo-random algorithm is adjusted responsive to an input at user input device 140, particularly adjusting one or more of the speed of translation and the maximum translation amount. Advantageously, the translation of support member 50 along axis 180 provides CPM to lumbar region 30 of user 20. In one embodiment (not shown), translation mechanism 130C is arranged to translate support member 50 along an axis 185, orthogonal to axis 180 and forming with axis 180 a plane 187 (not shown). In one embodiment, a separate motor 120 is provided for translation along axis 185. Preferably, the combination of translation paths along axis 180 and axis 185 allows for translation of support member 50 along any path within plane 187.

FIG. 2D illustrates a high level schematic diagram of the circuitry of a base 40D of back treatment apparatus 10. The arrangement and operation of base 40D is in all respects similar to base 40C of FIG. 2C with the exception that translation mechanism 130C is replaced with a translation mechanism 130D which is arranged, responsive to the operation of motor 120, to rotate support member 50 about axis 180 thereby supplying a tilt to support member 50. The rotation about axis 180 is performed alternately in opposing directions. In one embodiment, the number of degrees of rotation of support member 50 from a default position is a predetermined value, preferably no more than 30° about axis 180. In another embodiment, the degrees of rotation, and the rate of rotation, are adjusted according to a pseudo-random algorithm, preferably constrained to be within pre-determined translation limits, such as the above preferable 30° limit. In one embodiment, the degrees of rotation of support member 50 about axis 180 and the rate of rotation are adjusted responsive to an input at user input device 140. Advantageously, the rotation of support member 50 about axis 180 provides CPM to lumbar region 30 of user 20. In one embodiment (not shown), translation mechanism 130D is further arranged to rotate support member 50 about an axis 185, orthogonal to axis 180 and forming with axis 180 a plane 187 (not shown). In one embodiment, a separate motor 120 is provided for rotation about axis 185. Preferably, the combination of rotation about axis 180 and axis 185 allows for rotation of support member 50 about any axis within plane 187.

FIG. 2E illustrates a high level schematic diagram of the circuitry of a base 40E of back treatment apparatus 10. The arrangement and operation of base 40E provides all of the various translations and rotations of each of bases 40A-40D of FIGS. 2A-2D, with a plurality of motors 120A-120D responsive to a single driver 110. In further detail, motor 120A is connected to support member 50 by a translation mechanism 210. Motor 120A is arranged to rotate translation mechanism 210 about axis 170 thereof, thereby performing rotation of support member 50 as described above in relation to FIG. 2B. Motor 120A is secured to a platform 220 and motor 120B is in communication with platform 220 so as to provide translation of platform 220 along axis 180, as described above in relation to FIG. 2C. In one embodiment, motor 120B is further arranged to provide translation of platform 220 along any of a plurality of paths within plane 187 (not shown), as described above in relation to FIG. 2C. In particular, motor 120B, or an additional motor, may be arranged to provide translation of platform 220 along a path orthogonal to axes 170, 180. Motor 120C is in communication with translation mechanism 210, and is arranged to provide translation of platform 220 along axis 170 as described above in relation to FIG. 2A. Motor 120D is in communication with support member 50 via a linkage member 230, and is thus arranged to provide rotation of support member 50 about axis 180, as described above in relation to FIG. 2D. In one embodiment, motor 120D is further arranged to provide rotation of support member 50 about any axis within plane 187 (not shown), as described above in relation to FIG. 2D. In particular, in one embodiment motor 120D, or an additional motor, in cooperation with appropriate linkages, provides rotation about an axis orthogonal to axes 170, 180. Thus, motor 120D provides controlled tilt of support member 50 responsive to control circuitry 100.

In one embodiment, a plurality of drivers 110 are provided, each associated with a respective one of motors 120A-120D. In another embodiment, a single motor 120 is provided, with translation along and about axis 170, 180 performed by a series of mechanical connections to the single motor 120.

In operation, control circuitry 100 is arranged to translate support member 50 along a plurality of paths via translation mechanism 210, platform 220 and linkage member 230. Specifically, the plurality of paths comprises: a path along axis 170; a rotation path about axis 170; a path along axis 180 and any axis within plane 187; and a rotation path about axis 180 and any axis within plane 187, as described above in relation to FIGS. 2A-2D. In one embodiment, control circuitry 100 is arranged to translate support member 50 separately along each path. In one embodiment, control circuitry 100 is arranged to select each path, the rate of translation or rotation, and the amount of translation or rotation, according to a pseudo-random algorithm. In one embodiment, the pseudo-random algorithm is adjusted responsive to an input at user input device 140, particularly at least one of the rate of translation, the maximum rate of translation, the rate of rotation, the maximum rate of rotation, the amount of translation and the maximum amount of translation along each of the axes may be individually set.

In one embodiment, control circuitry 100 is arranged to simultaneously translate support member 50 along a plurality of paths. In one embodiment, control circuitry 100 is arranged to select the combination of translation paths according to a pseuo-random algorithm. In one embodiment, the pseudo-random algorithm is adjusted responsive to an input at user input device 140. In one embodiment, control circuitry 100 is arranged to contemporaneously translate support member 50 along at least one path and rotate support member 50 along at least one rotation path about a respective axis. In one further embodiment, control circuitry 100 is arranged to simultaneously translate support member 50 along at least one path and rotate support member 50 along at least one rotation path about a respective axis.

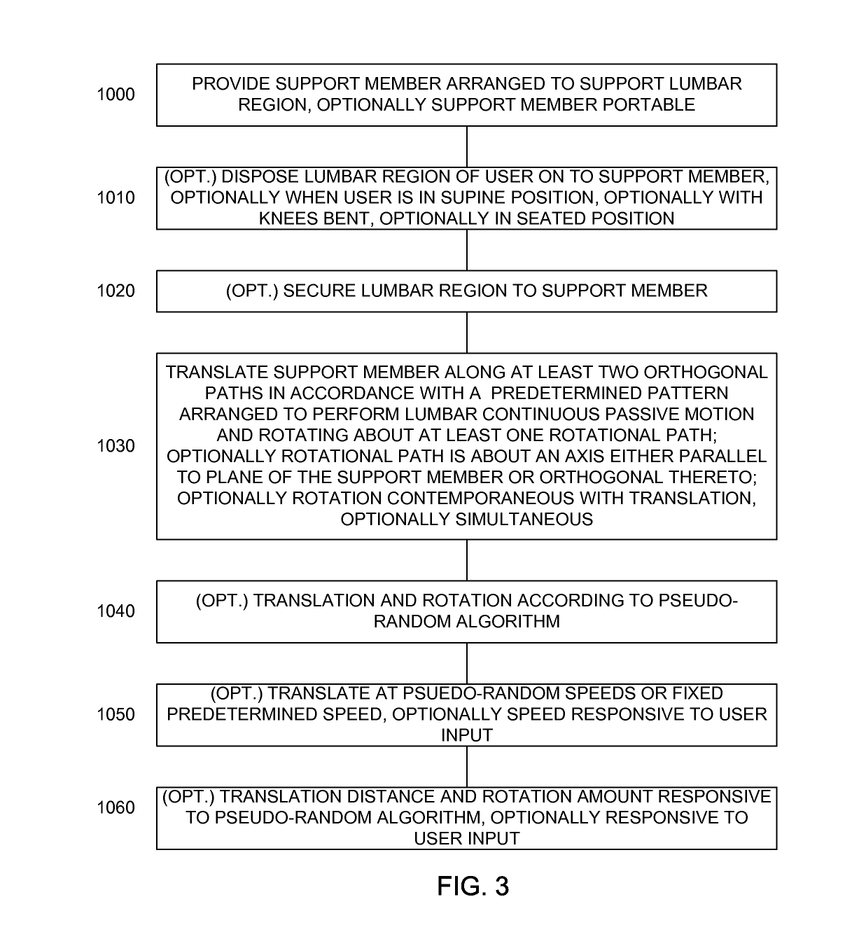

FIG. 3 illustrates a high level flow chart of a method of providing continuous passive motion (CPM). In stage 1000, a support member is provided arranged to support a lumbar region. In one embodiment, the support member is ergonomically shaped to more effectively support the lumbar region. In one embodiment, the support member is arranged to support a lumbar region of a user in a supine position. In one further embodiment, the support member is arranged to support a lumbar region of a user in a supine position with the knees bent. In another embodiment, the support member is arranged to support a lumbar region of a user in a seated position. In one embodiment, the dimensions and weight of the provided support member are such that the provided support member is portable. In optional stage 1010, a lumbar region of a user is disposed on to the provided support member of stage 1000. In one embodiment, the user is in a supine position, optionally with the knees bent. In another embodiment, the user is in a seated position. In optional stage 1020, the lumbar region is secured to the provided support member of stage 1000. In one embodiment, at least one securing member is provided, the securing accomplished in cooperation with the provided at least one securing member. In one embodiment, the at least one securing member is adjustable. In one embodiment, the at least one securing member is adapted to allow a user to grab the at least one securing member while in a supine position.

In stage 1030, the provided support member of stage 1000 is translated along a plurality of orthogonal paths and rotated about at least one axis in order to perform lumbar continuous passive motion. Preferably, the rotation is about one or more of an axis generally parallel in relation to the plane defined by the provided support member of stage 1000 and an axis generally perpendicular thereof. Optionally, the provided support member is rotated contemporaneously with the translation thereof. Further optionally, the provided support member is rotated simultaneously with the translation thereof.

In optional stage 1040, the translation and rotation of stage 1030 is according to a pseudo-random algorithm. In one embodiment, the provided support member of stage 1000 is separately translated along each of the plurality of orthogonal paths and rotated about each of the at least one axis of stage 1030, the selection of the particular path or axis responsive to the pseudo-random algorithm. In another embodiment, the provided support member is simultaneously translated along a plurality of paths, the combination of paths responsive to the pseudo-random algorithm. In another embodiment, the provided support member is simultaneously translated along at least one path and rotated about at least one axis, the combination responsive to the pseudo-random algorithm. In optional stage 1050, in one embodiment, the translation of stage 1030 and optional stage 1040 is performed over a range of rates of motion, selected according to a pseudo-random algorithm, and in another embodiment is performed at a fixed predetermined rate of motion. In one further embodiment, the translation rate of motion is responsive to a user input. In optional stage 1060, the distance of translation and amount of rotation of stage 1030 and optional stage 1040 is determined responsive to a pseudo-random algorithm and optionally further responsive to a user input.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination. In the claims of this application and in the description of the invention, except where the context requires otherwise due to express language or necessary implication, the word “comprise” or variations such as “comprises” or “comprising” is used in any inclusive sense, i.e. to specify the presence of the stated features but not to preclude the presence or addition of further features in various embodiments of the invention.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting. No admission is made that any reference constitutes prior art. The discussion of the reference states what their author's assert, and the applicants reserve the right to challenge the accuracy and pertinency of the cited documents. It will be clearly understood that, although a number of prior art complications are referred to herein, this reference does not constitute an admission that any of these documents forms part of the common general knowledge in the art in any country.

It will be appreciated by persons skilled in the art that the present invention is not limited to what has been particularly shown and described hereinabove.

Rather the scope of the present invention is defined by the appended claims and includes both combinations and sub-combinations of the various features described hereinabove as well as variations and modifications thereof, which would occur to persons skilled in the art upon reading the foregoing description.

1. A back treatment apparatus, comprising:
a support member arranged to support a lumbar region;
a translation mechanism; and
a control circuitry, said control circuitry arranged to control said translation mechanism to translate said support member along a plurality of paths and rotate said support member about at least one axis in a predetermined range of motion.

2. The back treatment apparatus of claim 1, wherein said plurality of paths comprises at least:
a generally linear path along an axis generally perpendicular in relation to a plane defined by said support member; and
a generally linear path along an axis generally parallel in relation to the plane defined by said support member.

3. The back treatment apparatus according to claim 1, wherein said rotation about said at least one axis comprises one of:
a rotational path about an axis generally parallel in relation to a plane defined by said support member; and
a rotational path about an axis generally perpendicular in relation to the plane defined by said support member.

4. The back treatment apparatus of claim 3, wherein said rotation is about both of said rotational path about an axis generally parallel in relation to the plane defined by said support member and said rotational path about an axis generally perpendicular in relation to the plane defined by said support member.

5. The back treatment apparatus of claim 1, wherein said control circuitry is further arranged to control said translation mechanism to translate said support member along said plurality of paths according to a pseudo-random algorithm.

6. The back treatment apparatus of claim 1, wherein said control circuitry is further arranged to control said translation mechanism such that the translation of said support member is performed at pseudo-random rates of motion.

7. The back treatment apparatus of claim 1, wherein said control circuitry is further arranged to control said translation mechanism such that one of said translation and rotation of said support member is performed at a fixed predetermined rate of motion.

8. The back treatment apparatus of claim 1, further comprising a user input device, wherein the rate of motion of one of said translation and rotation of said support member is responsive to an input at said user input device.

9. The back treatment apparatus of claim 1, wherein the distance of translation of said support member along said at least one path is responsive to a pseudo-random algorithm.

10. The back treatment apparatus of claim 1, further comprising a user input device, wherein the distance of translation of said support member along said at least one path is responsive to an input at said user input device.

11. The back treatment apparatus of claim 1, further comprising a securing member arranged to secure a lumbar region to said support member.

12. The back treatment apparatus of claim 11, wherein said securing member is adjustable.

13. The back treatment apparatus of claim 1, wherein said rotation is contemporaneous with said translation.

14. The back treatment apparatus of claim 1, wherein the back treatment apparatus is portable.

15. A method of providing continuous passive motion to a lumbar region, the method comprising:
translating a support member, arranged to support a lumbar region of a user, along at least two orthogonal paths, in accordance with a predetermined pattern arranged to perform lumbar continuous passive motion; and
rotating said provided support member about at least one rotational path.

16. The method according to claim 15, wherein said rotating is about one of:
an axis generally parallel in relation to a plane defined by said provided support member; and
an axis generally perpendicular in relation to the plane defined by said provided support member.

17. The method of claim 16, wherein said translating and said rotating are according to a pseudo-random algorithm.

18. The method of claim 15, wherein one of said translating and said rotating of said provided support member is performed over a range of rates of motion selected according to a pseudo-random algorithm.

19. The method of claim 15, wherein one of said translating and said rotating of said provided support member is performed at a fixed predetermined rate of motion.

20. The method of claim 1, wherein the rate of motion of one of said translation and said rotation is responsive to a user input.

21. The method of claim 15, wherein the distance of translation of said provided support member along each of the orthogonal paths and the amount of rotation of said provided support member is responsive to a pseudo-random algorithm.

22. The method of claim 15, wherein the distance of translation of said provided support member along each of the orthogonal paths and the amount of rotation of said provided support member is responsive to a user input.

23. The method of claim 15, further comprising securing a lumbar region to said provided support member.

24. The method of claim 15, wherein the user is in a supine position.

25. The method of claim 15, wherein the user is in a seated position.

26. The method of claim 15, wherein said rotating is contemporaneous with said translating.

27. The method of claim 15, wherein the support member is portable.
